(19) United States
(12) Patent Application Publication
(10) Pub. No.: US 2007/0013941 A1
(43) Pub. Date: Jan. 18, 2007

(54) System, printer, and method for distributing data to a plurality of printers

(75) Inventor: Brett Anno, Mundelein, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/183,584

(22) Filed: Jul. 18, 2005

(51) Int. Cl. G06F 3/12

(52) U.S. Cl. 358/1.15

(57) ABSTRACT

A system, printer, and method utilize a peer-to-peer packet sharing protocol that enables a large data file to be quickly and efficiently transferred to a large number of printers. A system for distributing data to a plurality of printers comprises a computer connected to a network, a first printer connected to the network, and a second printer connected to the network. The computer transmits a data packet over the network to the first printer. The first printer and the second printer each execute a peer-to-peer packet-sharing protocol, such as the BitTorrent Swarmcast, and Swarmstreaming protocols. The first printer transmits the data packet to the second printer.

### FIELD OF THE INVENTION

The present invention relates generally to printers, and more particularly, to methods of distributing data to a plurality of printers.

### BACKGROUND OF THE INVENTION

The existence of high speed networks that utilize communication protocols such as Ethernet has facilitated the transfer of data among various devices capable of interfacing with such networks. However, the transfer of very large amounts of data may still cause problems, particularly if the data is transferred to a large number of devices over a relatively short period of time. Transferring large amounts of data over a network may cause communications on the network to slow to unacceptably low speeds, such that important additional data does not reach the intended destination within the desired amount of time. Additionally, transferring large amounts of data from a single host or central device to a large number of remote devices may cause the performance of the host device to suffer while the data is being transferred, thereby preventing the host device from performing other tasks while the data is being transferred.

Certain businesses, such as manufacturing and/or distribution businesses, may utilize large numbers of printers, located across large geographic areas and connected via one or more network. Such a system of printers may be termed a printer network or a printer array. For example, a manufacturing business may have several manufacturing facilities located in several different countries. Each of these manufacturing facilities may have a printer network comprising several dozen or even several hundred printers used to print labels, such as bar code labels, that are applied to the manufactured products. A distribution business may have several warehouses, each in a different geographic location. Each of these warehouses may have printers on each conveyor system and/or at each shipping station used to print labels to help direct the warehoused products to the appropriate destinations. Such users of large printer networks will often only use a small number of different models of printers. Having many printers of one particular model facilitates maintenance and upgrades of the printers, as the printers will use the same operational software (termed firmware). Having many printers of one particular model also enables the same fonts to be used across many printers, as well as the same label layouts and graphics.

The problems described above that may exist when transferring large amounts of data over a network may also be encountered by these users of large printer networks. Such users of large printer networks may periodically have to transfer large data files to each printer for setup or maintenance purposes, such that identical data files are transferred to each of the many printers in the printer array. For example, new firmware may need to be transferred to each printer to correct a known problem or to install a new feature. Such a firmware file may be 1 to 20 megabytes in size. Font files, which enable a printer to print characters with defined typefaces or to print special characters, may need to be transferred to each of the many printers in the printer array. Font files, particularly font files that include global fonts, may be 20 to 30 megabytes in size. These firmware and font files would typically be downloaded from one central computer or server to the printers in the printer array. The transfer of a 10 to 30 megabyte file from one central computer to several hundred printers would likely cause data flow on the network to slow considerably. The transfer of other data files, which may be necessary to maintain business activities, could be curtailed during this time due to the traffic on the network. Such a transfer of that many large files from one central computer would likely occupy the computing resources of the central computer and thus prevent the central computer from performing any other necessary activities while the files are being transferred.

As such, there is a need for a method of transferring large data files over a network from a central computer to a large number of printers, such that the computing resources of the central computer are quickly freed up for other activities and network traffic flow is maintained.

### BRIEF SUMMARY OF THE INVENTION

A system, printer, and method are therefore provided that utilize a peer-to-peer packet sharing protocol that enables a large data file to be quickly and efficiently transferred to a large number of printers.

According to one embodiment of the present invention, a system for distributing data to a plurality of printers comprises a computer connected to a network, a first printer connected to the network, and a second printer connected to the network. The computer transmits a data packet over the network to the first printer. The first printer and the second printer each execute a peer-to-peer packet-sharing protocol, such as the BitTorrent protocol, the Swarmcast protocol, and the Swarmstreaming protocol. The first printer transmits the data packet to the second printer in response to a request by the second printer.

In one embodiment of the invention, the data packet is a first data packet. The computer transmits a second data packet to the second printer. The second printer transmits the second data packet to the first printer in response to a request by the first printer, such that the first printer and the second printer each possess the first data packet and the second data packet.

In one embodiment of the invention, the computer may transmit a plurality of data packets to the first printer, and the first printer may transmit the plurality of data packets to the second printer either in a push format or in a pull format where the second printer requests the data.

In one embodiment of the invention, the computer may transmit a first plurality of data packets to the first printer and a second plurality of data packets to the second printer. The first printer may transmit the first plurality of data packets to the second printer in either a push mode or in a pull mode where the second printer request the data, and the second printer may transmit the second plurality of data packets to the first printer in a push or pull mode.

In one embodiment of the invention, the computer may transmit a metadata file over the network to the first and second printers. The metadata file may comprise information regarding the data packet, thereby enabling the first and second printers to determine if each printer possesses the data packet and to determine if the data packet possessed by each printer is corrupted. In an alternative embodiment, the first and second printers may request the metadata file over the network from the computer.

In one embodiment, transmitting the data packet over the network to the first printer comprises broadcasting or multicasting the data packet, and transmitting the data packet from the first printer to the second printer comprises broadcasting or multicasting the data packet.

In addition to the system for distributing data to a plurality of printers as described above, other aspects of the present invention are directed to corresponding printers and methods for distributing data to a plurality of printers.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a prior art system for distributing data to a plurality of printers;

FIG. 2 is a schematic block diagram of a system for distributing data to a plurality of printers, according to one embodiment of the present invention;

FIG. 3 is a schematic block diagram of a system for distributing data to a plurality of printers, according to one embodiment of the present invention; and

FIG. 4 is a schematic block diagram of a printer for receiving distributed data from a computer and for distributing data to a second printer, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

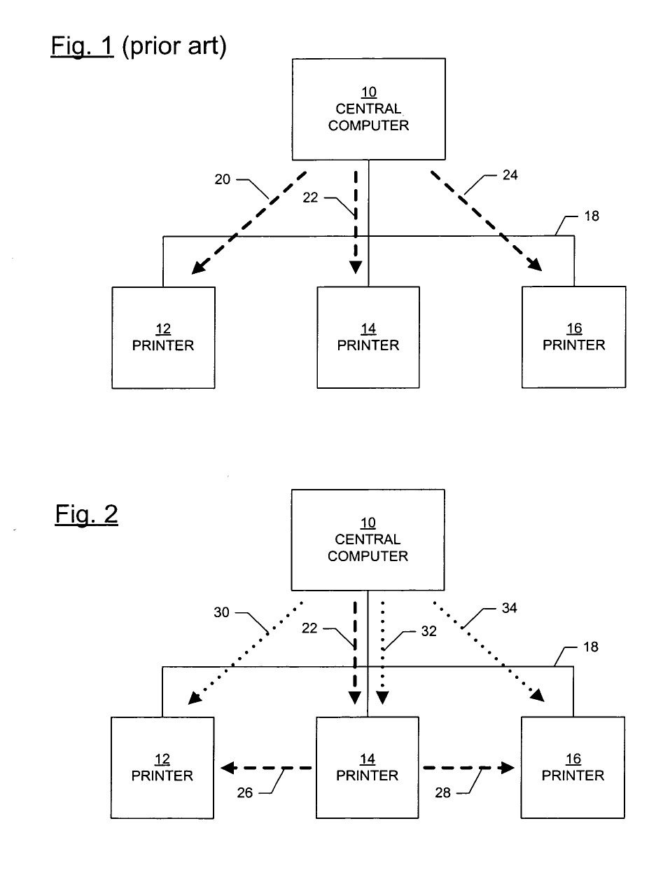

FIG. 1 is a schematic block diagram of a prior art system for distributing data to a plurality of printers. The system of FIG. 1 comprises a central computer 10, a first printer 12, a second printer 14, and a third printer 16, all connected via network 18. It should be appreciated that, while three printers are illustrated, the system of FIG. 1 may comprise any number of printers. It should also be appreciated that the network 18 may be any suitable network known to those skilled in the art, such as the Internet, LAN, WAN, WiFI, etc., and may utilize any suitable communication protocol, such as Ethernet.

In the prior art system of FIG. 1, the central computer 10 transfers a large data file to each of the three printers. The large data file may be, for example, a firmware upgrade, a new font file, a label graphic file that may be required to be installed on each of the three printers, one or more print jobs, etc. The central computer 10 transfers the complete data file over the network to the first printer 12, as illustrated by dashed line 20. The central computer 10 transfers the complete data file over the network to the second printer 14, as illustrated by dashed line 22. The central computer 10 transfers the complete data file over the network to the third printer 16, as illustrated by dashed line 24. The complete data file is transferred over the network by the central computer one time for each printer. Because the data file is large and the data file must be transferred multiple times over the network, the central computer 10 would be busy transferring the data such that the central computer may be unable to perform other important computing functions during the period of time that the data file is being transferred to each of the printers.

FIG. 2 is a schematic block diagram of a system for distributing data to a plurality of printers, according to one embodiment of the present invention. The system of FIG. 2 comprises a central computer 10, a first printer 12, a second printer 14, and a third printer 16, all connected via network 18. As in the prior art system of FIG. 1, it should be appreciated that the system of FIG. 2 may comprise any number of printers. Also, the network 18 may be any suitable network known to those skilled in the art and may use any suitable communication protocol. Unlike the prior art system of FIG. 1, in the system of FIG. 2 the printers are each executing a peer-to-peer packet sharing protocol (“P2P protocol”) (also termed a file swarming protocol), such as the BitTorrent, Swarmcast, and Swarmstreaming protocols.

In a P2P network, any peer (i.e., device capable of communicating on the network) is able to initiate communication with any other peer. This differs from client-server architecture, such as that shown in FIG. 1, where communication is usually to and from a central computer or server. Because a P2P network enables the bandwidth of all the peers to be used, the total bandwidth grows with the number of peers, thereby enabling faster distribution of data. A P2P protocol, such as BitTorrent, enables a data file to be transmitted as a series of data packets which together comprise the data file. The data packets may typically be transmitted in any order, including randomly. As the data packets are being received by a peer, or after all the data packets have been received by a peer, the peer reassembles the data packets into the data file.

In the system of FIG. 2, the central computer 10 may transmit a metadata file to the first printer 12 as indicated by the dotted line 30, to the second printer 14 as indicated by the dotted line 32, and to the third printer 16 as indicated by the dotted line 34. The metadata file typically corresponds to the data file to be transmitted, and comprises information regarding the data file. The metadata file provides information to the printers, such as how many data packets comprise the data file and how to assemble the data packets, enabling the printers to retrieve and assemble the data packets and to thereby obtain the data file. In an alternative embodiment of the invention, the metadata file may be requested by a printer from the central computer. The printer may request the metadata file on a repeated or periodic basis, such as once a day or once a month. Also, the printer may request the metadata file every time the printer is powered up.

The central computer may then transmit the data packets comprising the data file to one of the printers in the array, such as the second printer 14, as indicated by the dashed line 22. It should be appreciated that the data packets could be transmitted to any of the printers in the printer array. As discussed above, the data packets could be transmitted in any order. As the second printer 14 receives the data packets, the second printer will typically store the data packets in memory, thereby enabling the second printer to assemble the data packets when all data packets have been received and enabling the second printer to transmit the data packets to other printers as requested.

In a P2P protocol, such as BitTorrent, a device on the network typically functions as a “tracker.” A tracker maintains a log of which peers possess which data packets, thereby enabling a peer to determine from which other peer a needed data packet can be obtained. In the system of FIG. 2, the central computer 10 would typically function as a tracker. After the metadata file has been transmitted to the printers and the data packets have been transmitted to the second printer, the first printer 12 and the third printer 16 would be able to determine from the central computer 10 (i.e., the tracker) that the data packets needed by the first printer and the third printer are available from the second printer. The first and third printers would then typically communicate over the network with the second printer and request the needed data packets. The second printer would transmit the requested data packets over the network to the first printer and to the third printer, as illustrated by dashed line 26 and dashed line 28, respectively. The data packets would typically be requested one at a time from the second printer 14, and would typically be requested in a random order. As each data packet is transmitted from the second printer to the first printer and/or the third printer, the central computer 10 will keep track of which printers possess which data packets.

It should be appreciated that, for a large data file comprising a large number of data packets, the first and third printers would likely not obtain all of the data packets from the second printer. For example, if a particular data packet has been transmitted from the second printer 14 to the third printer 16 but has not yet been transmitted to the first printer 12, the first printer may then obtain that particular data packet either from the second printer or from the third printer. For a printer array comprising a large number of printers, as the data packets are requested by and transmitted to the printers in a random order, it should be appreciated that the number of printers that possess any one particular data packet will increase over time. Therefore, any printers that do not have a particular data packet will be able to request that data packet from any of an increasing number of printers. This ability to involve all of the peers in distributing all of the data packets quickly distributes the data file to all the peers, without causing any one device on the network to be occupied for an extended period of time transmitting the data packets to every peer.

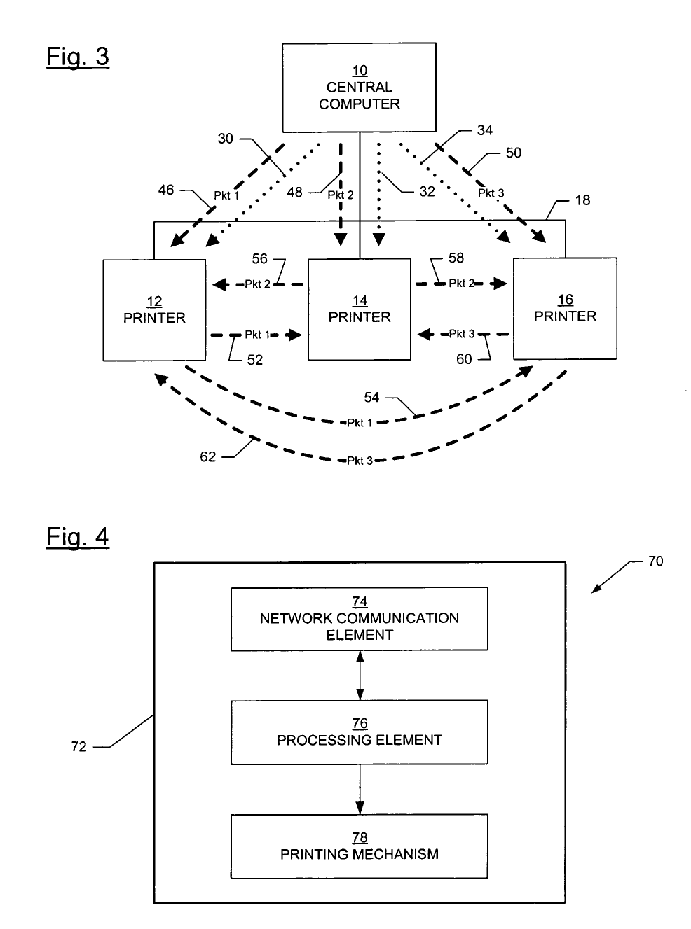

FIG. 3 is a schematic block diagram of a system for distributing data to a plurality of printers, according to one embodiment of the present invention. The system of FIG. 3 is similar to the system of FIG. 2, but FIG. 3 illustrates a different method of distributing the data packets from the central computer 10. As in the system of FIG. 2, the central computer 10 of FIG. 3 transmits a metadata file to the first printer 12 (illustrated by dashed line 30), the second printer 14 (illustrated by dashed line 32), and the third printer 16 (illustrated by dashed line 34). Rather than transmitting all of the data packets to one printer, the central computer 10 may transmit a different subset of the data packets to each of the different printers. In the simplified system of FIG. 3 in which the data file comprises three data packets (packet 1, packet 2, and packet 3), the central computer may transmit packet 1 to the first printer 12, as illustrated by dashed line 46. The central computer may transmit packet 2 to the second printer 14, as illustrated by dashed line 48. And the central computer may transmit packet 3 to the third printer 16, as illustrated by dashed line 50. As discussed above, the central computer 10 would typically track which printer has which data packet. The first printer 12 could determine from the metadata file that the first printer needs to obtain packet 2 and packet 3. The first printer could communicate with the central computer to determine that packet 2 can be obtained from the second printer 14 and that packet 3 could be obtained from the third printer 16. The first printer may request packet 2 from the second printer, and the second printer would transmit packet 2 to the first printer as illustrated by dashed line 56. The first printer may request packet 3 from the third printer, and the third printer would transmit packet 3 to the first printer as illustrated by dashed line 62. Similarly, the second printer 14 could obtain packet 1 from the first printer (as illustrated by dashed line 52) and could obtain packet 3 from the third printer (as illustrated by dashed line 60). Similarly, the third printer 16 could obtain packet 2 from the second printer (as illustrated by dashed line 58) and could obtain packet 1 from the first printer (as illustrated by dashed line 54).

In an alternative embodiment of the invention, rather than transmitting the packets to designated printers, the packets could be broadcast over a network or multicast over two or more networks. The packets could be broadcast and/or multicast from the central computer and/or any of the printers. When a packet is broadcast, the packet is typically transmitted to a predefined broadcast address. When a packet is multicast, the packet is typically transmitted to a predefined multicast address. As each packet is broadcast and/or multicast, any printer that is monitoring the broadcast and/or multicast address would typically decide whether to receive the packet. Such a decision would typically be based on whether the printer needs the packet, as indicated by the metadata file.

FIG. 4 is a schematic block diagram of a printer, according to one embodiment of the present invention. The printer 70 of FIG. 4 comprises a housing 72. Housing 72 comprises network communication element 74, processing element 76, and printing mechanism 78. The network communication element 74 enables the printer 70 to interface to a network and to thereby communicate with a central computer and other printers connected to the network to request, receive, and transmit data packets. The processing element 76 would typically execute the P2P protocol as described above. The processing element 76 would interface with the network communication element to facilitate communication with other devices on the network. The processing element would also receive, through the network communication element, the data to be printed. The processing element would then format the data for printing, and input the formatted data to the printing mechanism 76. The printing mechanism 76 would typically include a media support assembly, a drive assembly, and a print head assembly, which are not illustrated in FIG. 4 for simplicity but which are known to those skilled in the art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for distributing data to a plurality of printers, the system comprising:
a computer connected to a network;
a first printer connected to the network; and
a second printer connected to the network, wherein the computer transmits a data packet over the network to the first printer;
wherein the first printer and the second printer each execute a peer-to-peer packet-sharing protocol, and wherein the first printer transmits the data packet to the second printer.

2. The system of claim 1, wherein the peer-to-peer packet-sharing protocol is selected from the group comprising BitTorrent protocol, Swarmcast protocol, and Swarmstreaming protocol.

3. The system of claim 1, wherein the data packet is a first data packet; wherein the computer transmits a second data packet to the second printer; and wherein the second printer transmits the second data packet to the first printer, such that the first printer and the second printer each possess the first data packet and the second data packet.

4. The system of claim 1, wherein the computer transmits a plurality of data packets to the first printer, and wherein the first printer transmits the plurality of data packets to the second printer.

5. The system of claim 1, wherein the computer transmits a first plurality of data packets to the first printer, wherein the computer transmits a second plurality of data packets to the second printer, wherein the first printer transmits the first plurality of data packets to the second printer, and wherein the second printer transmits the second plurality of data packets to the first printer.

6. The system of claim 1, wherein the computer transmits a metadata file over the network to the first and second printers, the metadata file comprising information regarding the data packet, thereby enabling the first and second printers to determine if each printer possesses the data packet and to determine if the data packet possessed by each printer is corrupted.

7. The system of claim 1, wherein the first and second printers request a metadata file over the network from the computer, the metadata file comprising information regarding the data packet, thereby enabling the first and second printers to determine if each printer possesses the data packet and to determine if the data packet possessed by each printer is corrupted.

8. The system of claim 1, wherein said first printer in a pull mode transmits the data packet to the second printer in response to a request from the said second printer.

9. The system of claim 1, wherein said first printer in a push mode transmits the data packet to the second printer independent of a request from the said second printer.

10. The system of claim 1, wherein transmitting the data packet over the network to the first printer comprises broadcasting or multicasting the data packet, and wherein transmitting the data packet from the first printer to the second printer comprises broadcasting or multicasting the data packet.

11. A first printer for receiving distributed data from a computer and for distributing data to a second printer, the first printer comprising:
a core printer assembly comprising a media support assembly, a drive assembly, and a print head assembly;
a processing element for executing a peer-to-peer packet-sharing protocol;
a network communication element for enabling a connection via a network to the computer and the second printer;
wherein the first printer receives a data packet over the network from the computer; and
wherein the first printer transmits the data packet to the second printer.

12. The first printer of claim 11, wherein the peer-to-peer packet-sharing protocol is selected from the group comprising BitTorrent protocol, Swarmcast protocol, and Swarmstreaming protocol.

13. The first printer of claim 11, wherein the data packet is a first data packet;
wherein the computer transmits a second data packet to the second printer; and wherein the first printer receives the second data packet from the second printer, such that the first printer and the second printer each possess the first data packet and the second data packet.

14. The first printer of claim 11, wherein the first printer receives a plurality of data packets over the network from the computer, and wherein the first printer transmits the plurality of data packets to the second printer.

15. The first printer of claim 11, wherein the first printer receives a first plurality of data packets over the network from the computer, wherein the computer transmits a second plurality of data packets to the second printer, wherein the first printer transmits the first plurality of data packets to the second printer, and wherein the first printer receives the second plurality of data packets from the second printer.

16. The first printer of claim 11, wherein the first and second printers receive a metadata file from the computer, the metadata file comprising information regarding the data packet, thereby enabling the first and second printers to determine if each printer possesses the data packet and to determine if the data packet possessed by each printer is corrupted.

17. The first printer of claim 11, wherein the first and second printers request a metadata file over the network from the computer, the metadata file comprising information regarding the data packet, thereby enabling the first and second printers to determine if each printer possesses the data packet and to determine if the data packet possessed by each printer is corrupted.

18. The first printer of claim 11, wherein said first printer in a pull mode transmits the data packet to the second printer in response to a request from the said second printer.

19. The first printer of claim 11, wherein said first printer in a push mode transmits the data packet to the second printer independent of a request from the said second printer.

20. The first printer of claim 11, wherein transmitting the data packet from the first printer to the second printer comprises broadcasting or multicasting the data packet.

21. A first printer for receiving distributed data from a computer and for broadcasting or multicasting data, the first printer comprising:
a core printer assembly comprising a media support assembly, a drive assembly, and a print head assembly;
a processing element for executing a peer-to-peer packet-sharing protocol; and
a network communication element for enabling a connection via a network to the computer and a second printer;
wherein the first printer receives a data packet over the network from the computer, and wherein the first printer broadcasts or multicasts the data packet such that the data packet may be received by the second printer.

22. The first printer of claim 21, wherein the peer-to-peer packet-sharing protocol is selected from the group comprising BitTorrent protocol, Swarmcast protocol, and Swarmstreaming protocol.

23. The first printer of claim 21, wherein the data packet is a first data packet; wherein the computer transmits a second data packet to the second printer; wherein second data packet is broadcast or multicast by the second printer; and wherein the first printer receives the second data packet, such that the first printer and the second printer each possess the first data packet and the second data packet.

24. The first printer of claim 21, wherein the first printer receives a plurality of data packets over the network from the computer, and wherein the first printer broadcasts or multicasts the plurality of data packets such that the plurality of data packets may be received by the second printer.

25. The first printer of claim 21, wherein the first printer receives a first plurality of data packets over the network from the computer, wherein the computer transmits a second plurality of data packets to the second printer, wherein the first printer broadcasts or multicasts the first plurality of data packets such that the first plurality of data packets may be received by the second printer, and wherein the second printer broadcasts or multicasts the second plurality of data packets such that the second plurality of data packets may be received by the first printer.

26. The first printer of claim 21, wherein the first and second printers receive a metadata file from the computer, the metadata file comprising information regarding the data packet, thereby enabling the first and second printers to determine if each printer possesses the data packet and to determine if the data packet possessed by each printer is corrupted.

27. The first printer of claim 21, wherein the first and second printers request a metadata file over the network from the computer, the metadata file comprising information regarding the data packet, thereby enabling the first and second printers to determine if each printer possesses the data packet and to determine if the data packet possessed by each printer is corrupted.

28. A method of distributing data to a plurality of printers, the method comprising:
transmitting a data packet over a network to a first printer, the first printer executing a peer-to-peer packet-sharing protocol; and
transmitting the data packet over the network from the first printer to a second printer, the second printer executing the peer-to-peer packet-sharing protocol.

29. The method of claim 28, wherein the peer-to-peer packet-sharing protocol is selected from the group comprising BitTorrent protocol, Swarmcast protocol, and Swarmstreaming protocol.

30. The method of claim 28, wherein the data packet is a first data packet; wherein the method further comprises transmitting a second data packet to the second printer; wherein the method further comprises transmitting the second data packet over the network from the second printer to the first printer, such that the first printer and the second printer each possess the first data packet and the second data packet.

31. The method of claim 28, further comprising:
transmitting a plurality of data packets over the network to the first printer; and
transmitting the plurality of data packets over the network from the first printer to the second printer.

32. The method of claim 28, further comprising:
transmitting a first plurality of data packets over the network to the first printer;
transmitting a second plurality of data packets over the network to the second printer transmitting the first plurality of data packets over the network from the first printer to the second printer; and
transmitting the second plurality of data packets over the network from the second printer to the first printer.

33. The method of claim 28, further comprising:
transmitting a metadata file over the network to the first and second printers, the metadata file comprising information regarding the data packet, thereby enabling the first and second printers to determine if each printer possesses the data packet and to determine if the data packet possessed by each printer is corrupted.

34. The method of claim 28, further comprising:
requesting a metadata file by the first and second printers over the network from the computer, the metadata file comprising information regarding the data packet, thereby enabling the first and second printers to determine if each printer possesses the data packet and to determine if the data packet possessed by each printer is corrupted.

35. The method of claim 28, wherein said step of transmitting the data packet over the network from the first printer to a second printer in a pull mode transmits the data packet to the second printer in response to a request from the second printer.

36. The method of claim 28, wherein said step of transmitting the data packet over the network from the first printer to a second printer in a push mode transmits the data packet to the second printer independent of a request from the second printer.

37. The method of claim 28, wherein transmitting the data packet over the network to the first printer comprises broadcasting or multicasting the data packet, and wherein transmitting the data packet from the first printer to the second printer comprises broadcasting or multicasting the data packet.
